(19) United States
(12) Patent Application Publication
(10) Pub. No.: US 2026/0255028 A1
(43) Pub. Date: Aug. 27, 2026

(54) VIRTUAL SPACE PRESENTING DEVICE

(71) Applicant: NTT DOCOMO, INC., Tokyo (JP)

(72) Inventor: Momoko ABE, Chiyoda-ku (JP)

(73) Assignee: NTT DOCOMO, INC., Tokyo (JP)

(21) Appl. No.: 18/857,217

(22) PCT Filed: Apr. 11, 2023
(86) PCT No.: PCT/JP2023/014721

§ 371 Date: Oct. 16, 2024

(30) Foreign Application Priority Data
Apr. 22, 2022 (JP) 2022-070551

(51) Int. Cl. H04N 21/81; G06F 3/01; G06T 17/00

(52) U.S. Cl. CPC H04N 21/816; G06F 3/011; G06T 17/00

(57) ABSTRACT

A server includes an acquisition unit acquiring video data obtained by photographing users, a generation unit generating avatars corresponding to the users based on the video data, and a presentation unit presenting virtual space videos to the users. The acquisition unit is configured to be able to acquire first video data in which a first portion of a body of a user is shown within video data obtained by photographing the user in a plurality of different directions without acquiring second video data in which a second portion is shown during a period. The generation unit generates a first portion of an avatar of the user for the first period based on the first video data acquired during the first period and generates a second portion of the avatar for the first period based on the second video data acquired during a second period earlier than the first period.

### TECHNICAL FIELD

An aspect of the present invention relates to a virtual space presenting device.

### BACKGROUND ART

Patent Literature 1 discloses a system for generating a video of a virtual space including portrait videos of a plurality of users as a system for implementing communication via the virtual space between two or more users. Moreover, technology for generating 3D content (a volumetric video) by photographing a user who is a subject in all directions using a plurality of cameras or the like and reproducing the appearance, shape, movement, or the like of the subject as it is with high accuracy is known.

### CITATION LIST

### Patent Literature

[Patent Literature 1] Japanese Unexamined Patent Publication No. 2014-56308

### SUMMARY OF INVENTION

### Technical Problem

In a system like that disclosed in Patent Literature 1, it is conceivable to reflect 3D content of users in real time in a portrait video (an avatar) in a virtual space from the viewpoint of promoting communication between two or more users via a virtual space. However, when 3D content of each user's whole body is reflected in real time in each user's avatar arranged in the virtual space, a load on a graphics processing unit (GPU) increases and an amount of data transmission increases. As a result, there is a problem that a transmission delay, a processing failure, or the like occurs and the movement of the avatar in the virtual space becomes awkward, and therefore smooth communication is blocked.

Therefore, an objective of an aspect of the present invention is to present a virtual space presenting device capable of facilitating communication between users via a virtual space.

### Solution to Problem

According to an aspect of the present invention, there is provided a virtual space presenting device for presenting a three-dimensional virtual space shared by a plurality of users to each user, the virtual space presenting device including: an acquisition unit configured to acquire video data obtained by photographing users; a generation unit configured to generate avatars to be arranged in the virtual space in correspondence with the users on the basis of the video data of the users; and a presentation unit configured to generate and present videos corresponding to visual fields from virtual viewpoints of the users set in the virtual space with respect to the users, wherein the acquisition unit is configured to be able to acquire first video data in which a first portion of a body of a first user is shown within video data obtained by photographing the first user in a plurality of different directions without acquiring second video data in which a second portion different from the first portion of the body of the first user is shown during a first period, and wherein, when the acquisition unit acquires the first video data without acquiring the second video data during the first period, the generation unit generates the first portion of a first avatar corresponding to the first user for the first period on the basis of the first video data acquired during the first period, and generates the second portion of the first avatar for the first period on the basis of the second video data acquired during a second period earlier than the first period.

The virtual space presenting device according to the aspect of the present invention can reduce an amount of transmission of video data related to the first user by selectively acquiring only the first video data that is a part of the video data of the first user during the first period. As a result, it is possible to suppress the occurrence of a transmission delay, a processing failure, or the like due to the increase in the amount of data transmission. Furthermore, it is possible to implement the first avatar corresponding to the first user during the second period in an aspect in which the first avatar is less uncomfortable to other users by supplementing the second portion of which video data is not acquired during the first period from the second video data acquired in the second period earlier than the first period. As described above, the above-described virtual space presenting device can facilitate communication between users via the virtual space.

### Advantageous Effects of Invention

According to an aspect of the present invention, a virtual space presenting device capable of facilitating communication between users via a virtual space can be provided.

### BRIEF DESCRIPTION OF DRAWINGS

FIG. 1 is a diagram showing an example of a functional configuration of a virtual space presenting system according to an embodiment.

FIG. 2 is a diagram showing an example of a virtual space image presented to a user U2.

FIG. 3 is a sequence diagram showing an example of an operation of the virtual space presenting system.

FIG. 4 is a flowchart showing a first example of the processing of step S7 of FIG. 3.

FIG. 5 is a flowchart showing a second example of the processing of step S7 of FIG. 3.

FIG. 6 is a diagram showing an example of a hardware configuration of a server included in the virtual space presenting system.

### DESCRIPTION OF EMBODIMENTS

Hereinafter, embodiments of the present invention will be described in detail with reference to the accompanying drawings. In the description of the drawings, the same or equivalent elements are denoted by the same reference signs and redundant description thereof will be omitted.

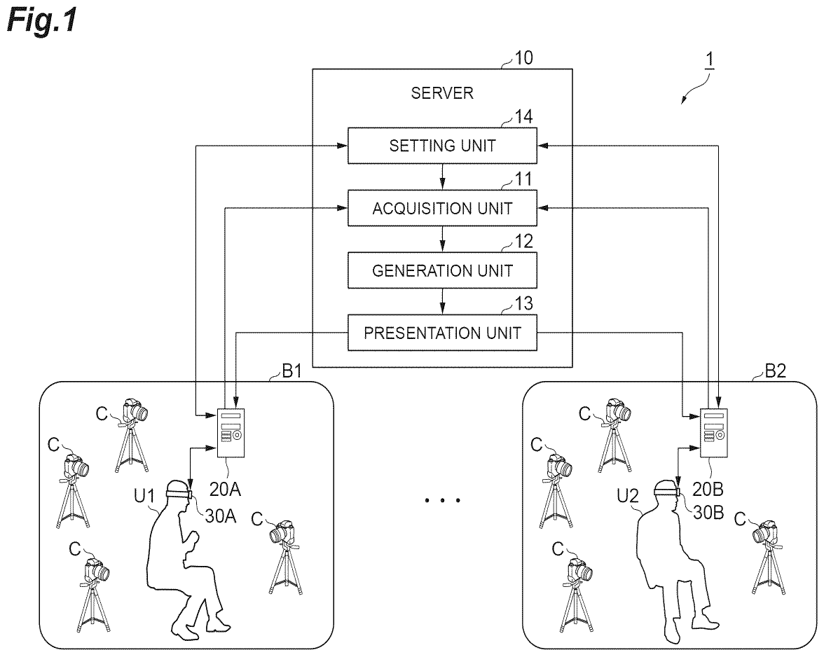

FIG. 1 is a diagram showing an example of a virtual space presenting system 1 according to an embodiment. The virtual space presenting system 1 is a system for providing communication via a virtual space between two or more users to a plurality of users scattered at a plurality of locations away from each other.

As an example, the virtual space presenting system 1 is configured to include a server 10 (a virtual space presenting device), user terminals 20A and 20B installed in the locations, head mounted displays (HMDs) 30A and 30B attached to the heads of users U1 and U2 at the locations, and a plurality of cameras C arranged in the locations.

Although only two locations B1 and B2 are exemplified in FIG. 1, there may be three or more locations when there are three or more users. Moreover, there may be a plurality of users within one location. In this case, an individual user terminal may be installed for each user or one user terminal may be shared by a plurality of users.

In the location B1, the user terminal 20A and a plurality of cameras C are installed and the user U1 (a first user) equipped with the HMD 30A is present. The plurality of cameras C installed in the location B1 are arranged around the user U1 so that the user U1 can be photographed in a plurality of different directions. The user terminal 20A acquires video data of the whole body of the user U1 by acquiring video data obtained in a photographing process of each camera C. In addition, when the number of cameras C installed in the location B1 is not sufficient (i.e., it is not possible to acquire video data of the whole body of the user U1 (video data showing the user U1 in any direction) by simply combining the video data obtained in photographing processes of the cameras C), the user terminal 20A may supplement video data of a missing portion with AI or the like. The video data of the user U1 acquired in the user terminal 20A as described above is transmitted to the server 10.

In the location B2, as in the location B1, the user terminal 20B and the plurality of cameras C are installed and the user U2 (a second user) equipped with the HMD 30B is present. The plurality of cameras C installed in the location B2 are arranged around the user U2 so that the user U2 can be photographed in a plurality of different directions. The user terminal 20B acquires video data of the whole body of the user U2 by acquiring video data obtained in photographing processes of the cameras C. In addition, when the number of cameras C installed in the location B2 is not sufficient (i.e., it is not possible to acquire video data of the whole body of the user U2 (video data showing the user U2 in any direction) by simply combining the video data obtained in the photographing processes of the cameras C), the user terminal 20B may supplement video data of a missing portion with AI or the like. The video data of the user U2 acquired by the user terminal 20B in this way is transmitted to the server 10.

The user terminals 20A and 20B are computer devices configured to communicate with the server 10 and a plurality of cameras C installed in the same location. The user terminals 20A and 20B are not limited to a specific form. Examples of the user terminals 20A and 20B include desktop PCs, laptop PCs, smartphones, tablet terminals, wearable terminals, and the like.

In the present embodiment, the user terminal 20A is configured to communicate with the HMD 30A. That is, the HMD 30A is configured to communicate with the server 10 via the user terminal 20A. Likewise, the user terminal 20B is configured to communicate with the HMD 30B and the HMD 30B is configured to communicate with the server 10 via the user terminal 20B. However, communication forms between the HMDs 30A and 30B and the server 10 are not limited to the above-described forms. For example, the HMDs 30A and 30B may be configured to perform direct data communication with the server 10 without relaying through the user terminals 20A and 20B.

The HMDs 30A and 30B are devices attached to the heads of the users U1 and U2. For example, the HMDs 30A and 30B include displays (display units) arranged in front of both users U1 and U2, sensors configured to detect postures (orientations, inclinations, or the like) of the HMDs 30A and 30B, and communication devices for transmitting and receiving data to and from the user terminals 20A and 20B. Moreover, each of the HMDs 30A and 30B includes a control unit (e.g., a computer device including a processor, a memory, or the like) that controls the operation of the display, sensor, communication device, or the like described above. Examples of the HMDs 30A and 30B include eyeglass-type devices (e.g., smart glasses such as so-called XR glasses), goggle-type devices, hat-type devices, and the like.

The users U1 and U2 enjoy a VR experience in which they can feel as if they are present in a virtual space by visually recognizing videos displayed on the displays of the HMDs 30A and 30B (virtual space videos to be described below).

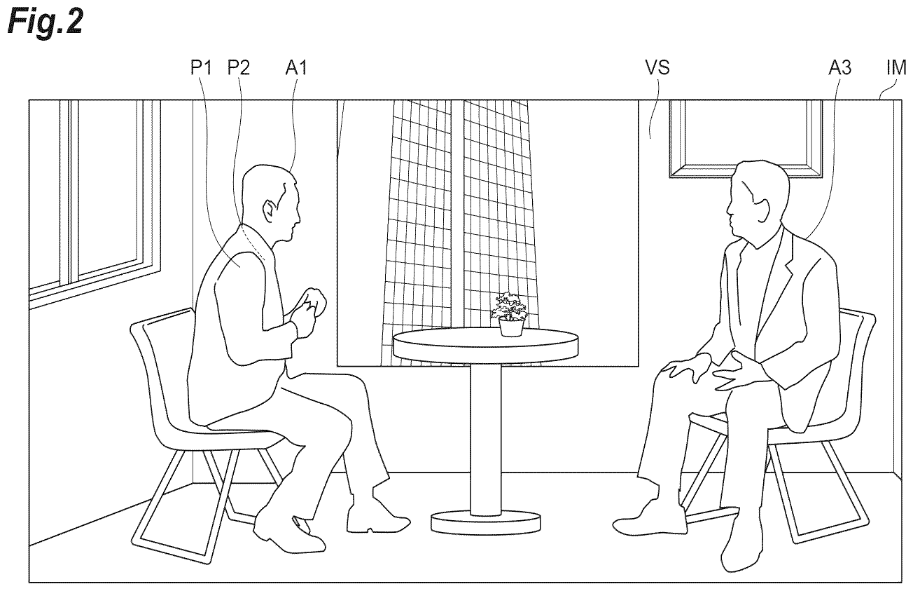

FIG. 2 is a diagram showing an example of a virtual space video IM that is a video presented from the server 10 to the user U2. The virtual space video IM presented to the user U2 is a video corresponding to a visual field from a virtual viewpoint of the user U2 set in a virtual space VS. In the present embodiment, the virtual viewpoint of the user U2 corresponds to a first-person viewpoint of the avatar A2 arranged in the virtual space VS in correspondence with the user U2. The virtual viewpoint of each user set in the virtual space VS may change with the movement of each user's head (i.e., the HMD attached to the head) (e.g., a change in a posture detected by the sensor mounted on the HMD). For example, when the user U2 performs an action of turning to the right in a real space, the head of the avatar A2 in the virtual space VS also turns to the right in accordance with the action, and as a result, the virtual viewpoint of the user U2 and the visual field from the virtual viewpoint may change.

In the example of FIG. 2, the virtual space VS is a space resembling a virtual office room, and an avatar A1 corresponding to the user U1, an avatar A2 corresponding to the user U2, and an avatar A3 corresponding to a user U3 other than the users U1 and U2 are arranged. More specifically, the avatars A1 to A3 are arranged to surround a table arranged in the virtual space VS. In addition, because the virtual space video IM shown in FIG. 2 is a video corresponding to the visual field from the virtual viewpoint of the user U2 (the visual field of the avatar A2), the avatar A2 is not shown. Virtual space videos corresponding to first-person viewpoints of the avatars A1 and A3 are presented to the users U1 and U3.

The server 10 is a device configured to implement communication via a virtual space VS between two or more users by presenting a three-dimensional virtual space VS shared by a plurality of users to each user. As shown in FIG. 1, the server 10 includes an acquisition unit 11, a generation unit 12, a presentation unit 13, and a setting unit 14.

The acquisition unit 11 acquires video data obtained by photographing users. In the present embodiment, the acquisition unit 11 acquires video data of the user U1 photographed by the plurality of cameras C installed in the location B1 from the user terminal 20A of the location B1 (i.e., video data obtained by photographing the user U1 in a plurality of different directions). Likewise, the acquisition unit 11 acquires video data of the user U2 photographed by the plurality of cameras C installed in the location B2 from the user terminal 20B of the location B2 (i.e., video data obtained by photographing the user U2 in a plurality of different directions). In addition, the acquisition unit 11 similarly acquires video data of other users.

Here, the acquisition unit 11 is configured to be able to selectively acquire only a part of the video data of the users so that amounts of data transmission from the user terminals 20A and 20B to the server 10 are reduced. Hereinafter, the configuration of the acquisition unit 11 focusing on the user U1 will be described. That is, a process in which the acquisition unit 11 selectively acquires only a part of the video data of the user U1 from the user terminal 20A so that the amount of data transmission from the user terminal 20A to the server 10 is reduced will be described.

The acquisition unit 11 acquires video data of the whole body of the user U1 obtained by photographing the user U1 in a plurality of different directions (e.g., photographing data of all cameras C installed in the location B1) during the period T1 (a second period). The period T1 is, for example, a period (e.g., several seconds) after a login process of the user U1 is completed (e.g., immediately after the user terminal 20A accesses the server 10, a predetermined authentication process is completed, and the user U1 is able to use communication via the virtual space VS presented by the server 10). That is, as an example, the acquisition unit 11 acquires video data of the whole body of the user U1 in the initial state immediately after the user U1 logs in. The video data of the whole body of the user U1 acquired during the period T1 is stored in a location accessible from the generation unit 12 to be described below (e.g., a memory 1002 or a storage 1003 to be described below). The video data of the user U1 acquired during the period T1 is used to supplement a portion of the avatar A1 (a second portion P2 to be described below) corresponding to any period T2 (a first period) later than the period T1.

The acquisition unit 11 is configured to be able to acquire first video data in which the first portion P1 as a portion of the body of the first user U1 is shown within video data obtained by photographing the first user U1 in a plurality of different directions (e.g., photographing data of all cameras C installed in the location B1) without acquiring second video data in which the second portion P2 different from the first portion P1 of the body of the first user U1 is shown during the period T2. In other words, during the period T2, the acquisition unit 11 is configured to be able to selectively acquire (receive) only the first video data in which the first portion P1 of the body of the user U1 is shown from the user terminal 20A within the video data of the whole body of the user U1 without acquiring (receiving) the second video data in which another portion (the second portion P2) is shown from the user terminal 20A. According to this configuration, because the transmission of the second video data from the user terminal 20A to the server 10 is omitted during the period T2, the amount of data transmission from the user terminal 20A to the server 10 can be reduced.

The generation unit 12 generates avatars arranged in the virtual space VS in correspondence with the users on the basis of the video data of the users acquired by the acquisition unit 11.

When the acquisition unit 11 acquires the video data of the whole body of the user U1 during the period T2 (e.g., photographing data of all cameras C installed in the location B1), the generation unit 12 can generate 3D content (e.g., a volumetric video) of the user U1 on the basis of the video data of the whole body and apply the 3D content to the avatar A1 of the user U1. That is, the realistic movement of the whole body of the user U1 during the period T2 can be reflected in the avatar A1 arranged in the virtual space VS.

On the other hand, when the acquisition unit 11 acquires first video data (i.e., video data in which the first portion P1 of the user U1 is shown) during the period T2 without acquiring second video data (i.e., video data in which the second portion P2 of the user U1 is shown), the generation unit 12 executes the following process.

That is, the generation unit 12 generates the first portion P1 of the avatar A1 (a first avatar) during the period T2 on the basis of the first video data acquired during the period T2. For example, the generation unit 12 generates partial 3D content in a state in which the second portion P2 is missing on the basis of the first video data acquired in the period T2. That is, the generation unit 12 can reflect the actual movement of the user U1 using the video data for the first portion P1 in which there is video data (first video data) obtained by photographing the actual movement of the user U1 during the period T2.

On the other hand, the generation unit 12 generates the second portion P2 of the avatar A1 for the period T2 (i.e., the missing portion of the partial 3D content) on the basis of the second video data acquired during the period T1 (the second period) earlier than the period T2. The generation unit 12, for example, supplements the avatar A1 for the period T2 by attaching a part configured to repeatedly reproduce the video of the second portion P2 of the avatar A1 acquired during the period T1 to the second portion P2 of the avatar A1 for the period T2 or attaching an image of the second portion P2 at a point in time included in the period T1 thereto. According to this process, it is possible to prevent the avatar A1 for the period T2 from becoming an avatar of an aspect in which the second portion P2 in which the video data during the period T2 has not been acquired is missing. In addition, because the shape of the avatar A1 is recognized at the stage in which the generation unit 12 creates the above-described 3D content, when the first portion P1 of the avatar A1 moves, the second portion P2 may be configured to move while tracking the movement of the first portion P1.

The presentation unit 13 generates and presents videos corresponding to visual fields from virtual viewpoints of users set in the virtual space VS with respect to the users. As described above, for example, the presentation unit 13 generates a video corresponding to a visual field from the virtual viewpoint of the user U2 (the first-person viewpoint of the avatar A2 corresponding to the user U2 in the present embodiment) as a virtual space video IM for the user U2 (see FIG. 2) and transmits the virtual space video IM to the user terminal 20B. The virtual space video IM transmitted to the user terminal 20B is transmitted to the HMD 30B of the user U2 and is displayed on the display provided in the HMD 30B. A process similar to the above-described process is also executed for a user other than the user U2.

The setting unit 14 sets the first portion P1 and the second portion P2 described above. A process of the setting unit 14 for setting the first portion P1 and the second portion P2 is performed dynamically. That is, the setting unit 14 appropriately updates the first portion P1 and the second portion P2 in accordance with a change in a situation. The setting unit 14 sets the first portion P1 and the second portion P2, for example, as follows.

### First Example

On the basis of a virtual viewpoint of a user (a second user) different from the user U1 among the plurality of users, the setting unit 14 sets the portion of the avatar A1 visible to the second user as the first portion P1 and sets the portion of the avatar A1 invisible to the second user as the second portion P2. That is, in the first example, the portion of the avatar A1 of the user Ul visible to other users (i.e., a portion that can promote nonverbal communication between the user U1 and other users by reflecting the real movement of the user U1) is set as the first portion P1 to reflect the movement of the user U1 in real time. On the other hand, because the portion of the avatar A1 of the user U1, which is not visible (invisible) to other users, is considered not to contribute much to the promotion of the nonverbal communication, the portion is set as the second portion P2.

It is assumed that there is no user U3 in the example of FIG. 2 for simplicity of description of the first example. That is, a process of the setting unit 14 in the first example will be described under the assumption that the second user who visually recognizes the avatar A1 is only the user U2. In this case, as shown in FIG. 2, the setting unit 14 sets the portion of the avatar A1 visible to the user U2 (mainly the portion including the right half of the user U1) as the first portion P1 and sets the portion of the avatar A1 invisible to the user U2 (mainly the portion including the left half of the user Ul and a portion of the avatar A1 that is opposite a side where the virtual viewpoint of the user U2 is located) as the second portion P2.

According to the first example, the first portion P1 and the second portion P2 can be appropriately set on the basis of a criterion of whether or not the portion is a portion visible to other users (i.e., a portion for which it is preferable to reflect the user's real movement to promote communication between users). That is, the amount of data transmission can be reduced by preventing the acquisition of video data (second video data) for the second portion P2 of the avatar A1 of the user Ul invisible to the other user U2. On the other hand, it is possible to facilitate communication between the users U1 and U2 by acquiring real-time video data (first video data) for the first portion P1 visible to the other user U2 and reflecting the acquired real-time video data in the avatar A1.

### Second Example

The setting unit 14 acquires movement information about the movement of the body of the user U1, sets a portion of which predetermined movement or more has been detected in the body of the user U1 as the first portion P1 on the basis of the movement information, and sets a portion of which predetermined movement or more has not been detected in the body of the user U1 as the second portion P2. For example, a portion of which predetermined movement or more has been detected in the body of the user U1 (or a portion that does not have the predetermined movement or more) may be detected by the user terminal 20A on the basis of video data obtained in photographing processes of the plurality of cameras C installed in the location B1. In this case, the setting unit 14 may ascertain the portion of which predetermined movement or more has been detected within the body of the user U1 (or a portion of which predetermined movement or more has not been detected) by acquiring a detection result from the user terminal 20A. Here, the “predetermined movement or more” is movement exceeding any predetermined standard related to the movement (e.g., a standard for a movement distance, a movement speed, or the like). For example, the predetermined movement or more may be movement of a predetermined threshold distance within a predetermined threshold period or movement of a preset threshold distance or more at a speed higher than or equal to a predetermined threshold speed.

According to the second example, it is possible to reflect the realistic movement of the user U1 in the avatar A1 by acquiring video data (first video data) of the first portion P1 of which movement is present within the body of the user U1. On the other hand, it is possible to reduce an amount of data transmission by supplementing the avatar A1 with previous video data (second video data acquired during the period T1) without acquiring real-time video data (second video data during the period T2) with respect to the second portion P2 of which movement is absent within the body of the user U1.

In the above-described second example, the following problems may occur if a method in which the portion is set as the second portion P2 until movement is detected and the portion is switched to the first portion P1 when movement has been detected is adopted. That is, there is a time lag between the time when a portion A set as the second portion P2 of the body of the user U1 moves and the time when the portion A is set as the first portion P1. As a result, there is a problem that the acquisition unit 11 cannot acquire video data during a period X from the time when the portion A starts to move to the time when the portion A is set as the first portion P1 and the generation unit 12 may not be able to reflect the movement of the portion A during the period X in the avatar A1. As a result, when the movement of the portion A of the user U1 is reflected in the avatar A1 after the elapse of the period X (i.e., after the video data of the portion A of the user U1 is acquired), other users may feel as if the portion A of the avatar A1 warps. That is, there is a problem that the movement of the avatar A1 will be unnatural from the perspective of other users due to the loss of video data during the period X corresponding to the above-described time lag.

Therefore, in the above-described second example, the setting unit 14 may set the whole body of the user U1 as the first portion P1 in an initial state. Also, the setting unit 14 may change a portion of which predetermined movement or more has not been detected continuously during a predetermined period (e.g., 10 sec or the like) within the first portion P1 to the second portion P2. Moreover, the setting unit 14 may change the second portion P2 of which movement has been detected to the first portion P1 when the predetermined movement or more has been detected in the second portion P2. According to the above-described configuration, the occurrence of the above-described problems can be avoided and it is possible to move the avatar A1 more naturally in the virtual space VS.

The setting unit 14 notifies the user terminal 20A of setting information indicating the first portion P1 and the second portion P2 of the user U1. As a result, when a process of transmitting the video data of the user U1 to the server 10 is executed, the user terminal 20A can selectively transmit only the video data (first video data) of the first portion P1 to the server 10 with reference to the above-described setting information.

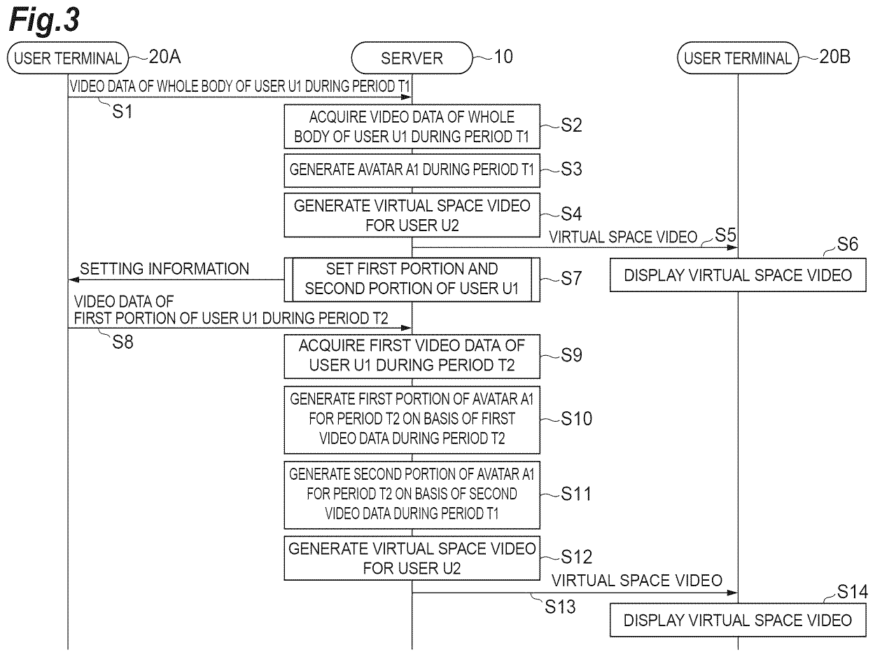

Next, an example of an operation of the virtual space presenting system 1 will be described with reference to FIG. 3. Here, the operation focuses on a process of presenting a virtual space video IM including an avatar A1 generated on the basis of video data of the user U1 to another user (the user U2). That is, the server 10 also performs a process of reversing a relationship between the user U1 and the user U2 (i.e., a process of generating a virtual space image including an avatar A2 generated on the basis of video data of the user U2 and presenting the virtual space image to the user U1). However, because this process is similar to a process to be described below, description thereof will be described.

In step S1, the user terminal 20A transmits video data of the whole body of the user U1 during the period T1 (the second period) (e.g., the photographing data of all cameras C installed in the location B1 during the period T1) to the server 10. The period T1 is, for example, a certain period (several seconds) immediately after the completion of a login process of the user U1.

In step S2, the acquisition unit 11 acquires (receives) video data of the whole body of the user U1 during the period T1 from the user terminal 20A.

In step S3, the generation unit 12 generates an avatar A1 for the period T1 on the basis of the video data during the period T1 acquired by the acquisition unit 11. For example, the generation unit 12 generates 3D content (e.g., a volumetric video) of the user U1 on the basis of the video data of the whole body of the user U1 during the period T1 and applies the 3D content to the avatar A1 of the user U1.

In steps S4 and S5, the presentation unit 13 generates a virtual space video IM (see FIG. 2) corresponding to a visual field from a virtual viewpoint of the user U2 set in the virtual space VS and transmits the virtual space video IM to the user terminal 20B.

In step S6, the user terminal 20B, which has received the virtual space video IM from the server 10, causes the virtual space video IM to be displayed on the display of the HMD 30B attached to the head of the user U2. According to the above-described process, a video of the virtual space VS including the avatar A1 in which the movement of the whole body of the user U1 during the period T1 is realistically reflected is presented to the user U2.

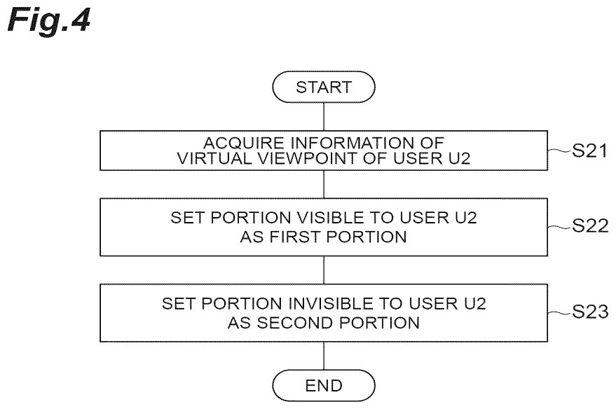

In step S7, the setting unit 14 sets the first portion Pl and the second portion P2 of the user U1. When the process of the above-described first example is executed, the setting unit 14 executes the process shown in the flowchart of FIG. 4 (steps S21 to S23). Here, it is assumed that the user U2 is only a user who can visually recognize the avatar A1 for simplicity of description.

In step S21, the setting unit 14 acquires information of the virtual viewpoint of the user U2. For example, the setting unit 14 identifies a visual field of the user U2 from the virtual viewpoint of the user U2 (i.e., a region included in the virtual space video IM as shown in FIG. 2). As described above, when the virtual viewpoint (and visual line direction) of the user U2 changes with a posture of the HMD 30B, the setting unit 14 may identify the visual field of the user U2 on the basis of information about the posture of the HMD 30B. Alternatively, when an arrangement relationship between the avatars of the users and the virtual visual line in the virtual space VS are fixed, the visual field of the user U2 may be identified on the basis of setting information about the arrangement relationship between the avatars and the virtual viewpoint.

In step S22, the setting unit 14 sets a portion of the avatar A1 visible to the user U2 as the first portion P1.

In step S23, the setting unit 14 sets a portion of the avatar A1 invisible to the user U2 as the second portion P2.

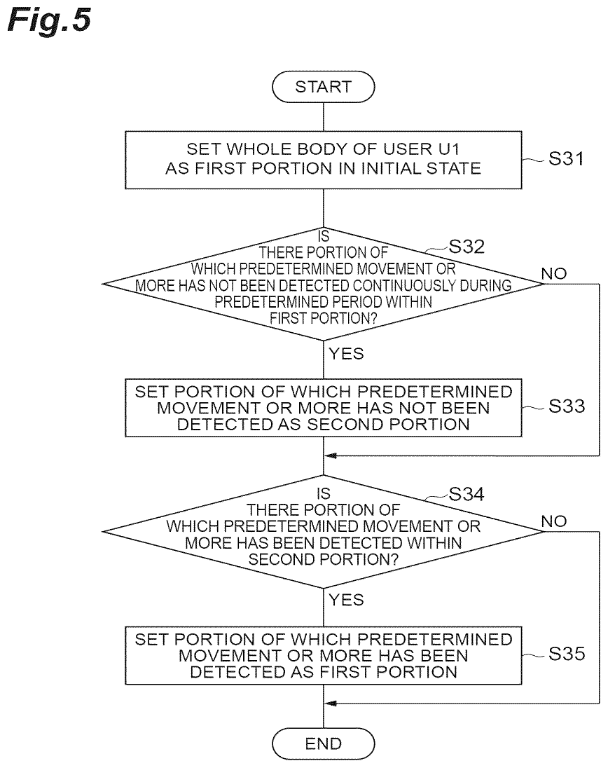

On the other hand, when the process of the above-described second example is executed, the setting unit 14 executes the process shown in the flowchart of FIG. 5 (steps S31 to S35).

In step S31, the setting unit 14 sets the whole body of the user U1 as the first portion P1 in an initial state.

In step S32, the setting unit 14 determines whether or not there is a portion of which predetermined movement or more has not been detected continuously for a predetermined period within the first portion P1.

When it is determined that there is a portion of which predetermined movement or more has not been detected continuously for a predetermined period within the first portion P1 in step S32 (step S32: YES), the setting unit 14 sets the portion as the second portion P2 (step S33). On the other hand, when it is determined that there is no portion of which predetermined movement or more has not been detected continuously during a predetermined period within the first portion P1 in step S32 (step S32: NO), the processing of step S33 is skipped.

In step S34, the setting unit 14 determines whether or not there is a portion of which predetermined movement or more has been detected within the second portion P2.

When it is determined that there is a portion of which predetermined movement or more has been detected within the second portion P2 in step S34 (step S33: YES), the setting unit 14 sets the portion as the first portion P1 (step S35). On the other hand, when it is determined that there is no portion of which predetermined movement or more has been detected within the second portion P2 in step S34 (step S32: NO), the processing of step S35 is skipped.

A notification of setting information indicating the first portion P1 and the second portion P2 set in step S7 is provided from the server 10 to the user terminal 20A. After the notification of this setting information, the processing of steps S8 to S14 is executed. In addition, the processing of step S7 and the setting information notification process can be executed periodically. That is, the first portion P1 and the second portion P2 can dynamically change with a change in a situation.

In step S8, the user terminal 20A transmits video data (first video data) of the first portion P1 of the user U1 during the period T2 (the first period) later than the period T1 (the second period) to the server 10.

In step S9, the acquisition unit 11 acquires (receives) the first video data of the first portion P1 of the user U1 during the period T2 from the user terminal 20A.

In step S10, the generation unit 12 generates the first portion P1 of the avatar A1 for the period T2 on the basis of the first video data acquired during the period T2. That is, the generation unit 12 generates the first portion P1 of the avatar A1 so that the actual movement of the user U1 in the period T2 is reflected. For example, the generation unit 12 generates partial 3D content in a state in which the second portion P2 is missing.

In step S11, the generation unit 12 generates the second portion P2 of the avatar A1 for the period T2 (i.e., the missing portion of the above-described partial 3D content) on the basis of the second video data acquired during the period T1 earlier than the period T2 (the data acquired in step S2 in the example of FIG. 3). That is, the generation unit 12 supplements the second portion P2 of the avatar A1 on the basis of previous video data. As a result, although the second portion P2 does not reflect the actual movement of the user U1 during the period T2, it is possible to generate the avatar A1 of a shape of a more natural shape in which the second portion P2 is not missing (a shape less uncomfortable to other users).

The processing of steps S12 and S13 is similar to the processing of steps S4 and S5. That is, the presentation unit 13 generates a virtual space video IM (see FIG. 2) corresponding to the visual field from the virtual viewpoint of the user U2 set in the virtual space VS and transmits the virtual space video IM to the user terminal 20B.

The processing of step S14 is similar to the processing of step S6. That is, the user terminal 20B receiving the virtual space video IM from the server 10 causes the virtual space video IM to be displayed on the display of the HMD 30B attached to the head of the user U2. According to the above-described process, the movement of the first portion P1 of the user U1 during the period T2 is realistically reflected with respect to the user U2, while a video of the virtual space VS including the avatar A1 supplemented on the basis of the data of the second portion P2 of the user U1 during a previous period (the period T1) is presented with respect to the second portion P2.

According to the server 10 (the virtual space presenting system 1), an amount of transmission of video data related to the user U1 can be reduced by selectively acquiring only the first video data that is a part of the video data of the user U1 during the period T2. As a result, it is possible to suppress the occurrence of a transmission delay, a processing failure, or the like due to the increase in the amount of data transmission. Furthermore, it is possible to implement the avatar A1 corresponding to the user U1 during the period T1 in an aspect in which the avatar A1 is less uncomfortable to another user U2 by supplementing the second portion P2 of which video data is not acquired during the period T2 from the video data (the second video data in which the second portion P2 is shown) acquired during the period T1 earlier than the period T2. As described above, according to the server 10 (the virtual space presenting system 1), communication between users via the virtual space VS can be facilitated.

In addition, when the setting unit 14 sets a portion invisible to the other user U2 as the second portion P2 as in the first example, it seems that there is no need to supplement the second portion P2 of the avatar A1 on the basis of previous video data. That is, if the user U2 cannot visually recognize a region corresponding to the second portion P2 originally, it seems that there is no problem even if the second portion P2 of the avatar A1 is left missing. However, for example, there is a possibility that the virtual viewpoint of the other user U2 set in the virtual space VS will change rapidly (e.g., will be switched from the first-person viewpoint of the avatar A2 to a position where the virtual space VS can be viewed from a bird's-eye view). Moreover, the orientation of the avatar A1 may change rapidly in conjunction with the user U1 performing an action to change the orientation of the body (the first portion P1 of the avatar A1 may move rapidly). In this case, there is a possibility that the second portion P2 of the avatar A1 previously invisible to the user U2 will be suddenly visible to the user U2. In this case, if the second portion P2 of the avatar A1 is missing, there is a problem that the missing portion is visible to the user U2 and the quality of the VR experience of the user U2 is impaired as a result of giving a sense of discomfort to the user U2. Therefore, even if the setting unit 14 executes the process of the first example, it is possible to avoid the above-described problem by generating (supplementing) the second portion P2 on the basis of previous video data and maintain the quality of the VR experience of the user U2.

In addition, the aspect of the virtual space presenting device of the present disclosure is not limited to the above-described embodiment. For example, in the first example, when the avatar A1 is visible to a plurality of users U2 and U3, the setting unit 14 may set the portion of the avatar A1 visible to at least one of the users U2 and U3 as the first portion P1 and set a portion of the avatar invisible to at least one of the users U2 and U3 as the second portion P2.

Although the virtual space presenting device includes only the server 10 in the above-described embodiment, some functions of the server 10 may be executed by another device (e.g., a user terminal of each location). In this case, the virtual space presenting device includes a system including the server 10 and the user terminal.

Moreover, in the virtual space presenting system 1, an HMD attached to each user's head is not essential. For example, in each location, a normal display device may be arranged in front of the user instead of the HMD. In this case, although a sense of immersion in the virtual space VS is lower than in a case where the HMD is used, the user can enjoy communication with other users via the virtual space VS by visually recognizing the virtual space video IM displayed on the display device.

The block diagrams used in the description of the embodiment show blocks in units of functions. These functional blocks (components) are realized in any combination of at least one of hardware and software. Further, a method of realizing each functional block is not particularly limited. That is, each functional block may be realized using one physically or logically coupled device, or may be realized by connecting two or more physically or logically separated devices directly or indirectly (for example, using a wired scheme, a wireless scheme, or the like) and using such a plurality of devices. The functional block may be realized by combining the one device or the plurality of devices with software.

The functions include judging, deciding, determining, calculating, computing, processing, deriving, investigating, searching, confirming, receiving, transmitting, outputting, accessing, resolving, selecting, choosing, establishing, comparing, assuming, expecting, regarding, broadcasting, notifying, communicating, forwarding, configuring, reconfiguring, allocating, mapping, assigning, or the like, but not limited thereto.

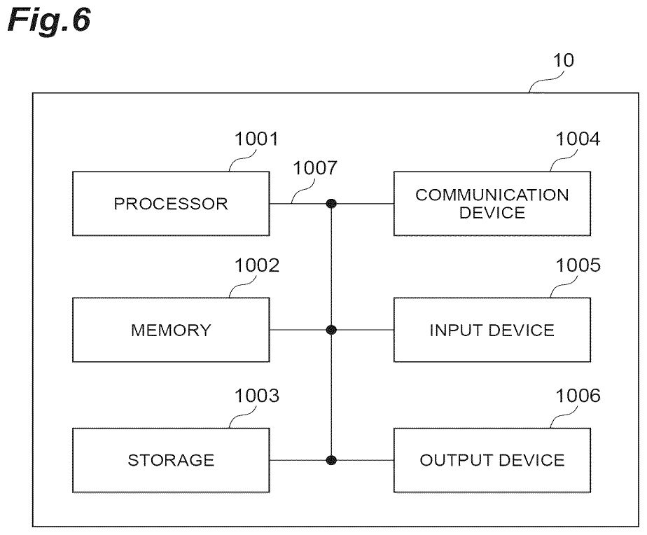

For example, the server 10 according to an embodiment of the present invention may function as a computer that performs virtual space presenting method of the present disclosure. FIG. 6 is a diagram illustrating an example of a hardware configuration of the server 10 according to the embodiment of the present disclosure. The server 10 described above may be physically configured as a computer device including a processor 1001, a memory 1002, a storage 1003, a communication device 1004, an input device 1005, an output device 1006, a bus 1007, and the like.

In the following description, the term “device” can be referred to as a circuit, a device, a unit, or the like. The hardware configuration of the server 10 may include one or a plurality of devices illustrated in FIG. 6, or may be configured without including some of the devices.

Each function in the server 10 is realized by loading predetermined software (a program) into hardware such as the processor 1001 or the memory 1002 so that the processor 1001 performs computation to control communication that is performed by the communication device 1004 or control at least one of reading and writing of data in the memory 1002 and the storage 1003.

The processor 1001, for example, operates an operating system to control the entire computer. The processor 1001 may be configured as a central processing unit (CPU) including an interface with peripheral devices, a control device, a computation device, a register, and the like.

Further, the processor 1001 reads a program (program code), a software module, data, or the like from at one of the storage 1003 and the communication device 1004 into the memory 1002 and executes various processes according to the program, the software module, the data, or the like. As the program, a program for causing the computer to execute at least some of the operations described in the above-described embodiment may be used. For example, each functional unit (e.g., the acquisition unit 11) of the server 10 may be realized by a control program that is stored in the memory 1002 and operated on the processor 1001, and other functional blocks may be realized similarly. Although the case in which the various processes described above are executed by one processor 1001 has been described, the processes may be executed simultaneously or sequentially by two or more processors 1001. The processor 1001 may be realized using one or more chips. The program may be transmitted from a network via an electric communication line.

The memory 1002 is a computer-readable recording medium and may be configured of, for example, at least one of a read only memory (ROM), an erasable programmable ROM (EPROM), an electrically erasable programmable ROM (EEPROM), and a random access memory (RAM). The memory 1002 may be referred to as a register, a cache, a main memory (a main storage device), or the like. The memory 1002 can store an executable program (program code), software modules, and the like in order to implement the virtual space presenting method according to the embodiment of the present disclosure.

The storage 1003 is a computer-readable recording medium and may also be configured of, for example, at least one of an optical disc such as a compact disc ROM (CD-ROM), a hard disk drive, a flexible disc, a magneto-optical disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The storage medium described above may be, for example, a database including at least one of the memory 1002 and the storage 1003, a server, or another appropriate medium.

The communication device 1004 is hardware (a transmission and reception device) for performing communication between computers via at least one of a wired network and a wireless network and is also referred to as a network device, a network controller, a network card, or a communication module, for example.

The input device 1005 is an input device (for example, a keyboard, a mouse, a microphone, a switch, a button, or a sensor) that receives an input from the outside. The output device 1006 is an output device (for example, a display, a speaker, or an LED lamp) that performs output to the outside. The input device 1005 and the output device 1006 may have an integrated configuration (for example, a touch panel).

Further, the respective devices such as the processor 1001 and the memory 1002 are connected by the bus 1007 for information communication. The bus 1007 may be configured using a single bus or may be configured using buses different between the devices.

Further, the server 10 may include hardware such as a microprocessor, a digital signal processor (DSP), an application specific integrated circuit (ASIC), a programmable logic device (PLD), or a field programmable gate array (FPGA), and some or all of the functional blocks may be realized by the hardware. For example, the processor 1001 may be implemented by at least one of these pieces of hardware.

Although the present embodiment has been described in detail above, it is apparent to those skilled in the art that the present embodiment is not limited to the embodiments described in the present disclosure. The present embodiment can be implemented as a modification and change aspect without departing from the spirit and scope of the present invention determined by description of the claims. Accordingly, the description of the present disclosure is intended for the purpose of illustration and does not have any restrictive meaning with respect to the present embodiment.

A process procedure, a sequence, a flowchart, and the like in each aspect/embodiment described in the present disclosure may be in a different order unless inconsistency arises. For example, for the method described in the present disclosure, elements of various steps are presented in an exemplified order, and the elements are not limited to the presented specific order.

Input or output information or the like may be stored in a specific place (for example, a memory) or may be managed in a management table. Information or the like to be input or output can be overwritten, updated, or additionally written. Output information or the like may be deleted. Input information or the like may be transmitted to another device.

A determination may be performed using a value (0 or 1) represented by one bit, may be performed using a Boolean value (true or false), or may be performed through a numerical value comparison (for example, comparison with a predetermined value).

Each aspect/embodiment described in the present disclosure may be used alone, may be used in combination, or may be used by being switched according to the execution. Further, a notification of predetermined information (for example, a notification of “being X”) is not limited to be made explicitly, and may be made implicitly (for example, a notification of the predetermined information is not made).

Software should be construed widely so that the software means an instruction, an instruction set, a code, a code segment, a program code, a program, a sub-program, a software module, an application, a software application, a software package, a routine, a sub-routine, an object, an executable file, a thread of execution, a procedure, a function, and the like regardless whether the software is called software, firmware, middleware, microcode, or hardware description language or called another name.

Further, software, instructions, information, and the like may be transmitted and received via a transmission medium. For example, when software is transmitted from a website, a server, or another remote source using wired technology (a coaxial cable, an optical fiber cable, a twisted pair, a digital subscriber line (DSL), or the like) and wireless technology (infrared rays, microwaves, or the like), at least one of the wired technology and the wireless technology is included in a definition of the transmission medium.

The information, signals, and the like described in the present disclosure may be represented using any of various different technologies. For example, data, an instruction, a command, information, a signal, a bit, a symbol, a chip, and the like that can be referred to throughout the above description may be represented by a voltage, a current, an electromagnetic wave, a magnetic field or a magnetic particle, an optical field or a photon, or an arbitrary combination of them.

Further, the information, parameters, and the like described in the present disclosure may be expressed using an absolute value, may be expressed using a relative value from a predetermined value, or may be expressed using another corresponding information.

Names used for the above-described parameters are not limited names in any way. Further, equations or the like using these parameters may be different from those explicitly disclosed in the present disclosure. Since various information elements can be identified by any suitable names, the various names assigned to these various information elements are not limited names in any way.

The description “based on (on the basis of)” used in the present disclosure does not mean “based only on” unless otherwise noted. In other words, the description “based on” means both of “based only on” and “based at least on”.

Any reference to elements using designations such as “first,” “second,” or the like used in the present disclosure does not generally limit the quantity or order of those elements. These designations may be used in the present disclosure as a convenient way for distinguishing between two or more elements. Thus, the reference to the first and second elements does not mean that only two elements can be adopted there or that the first element has to precede the second element in some way.

When “include”, “including” and transformation of them are used in the present disclosure, these terms are intended to be comprehensive like the term “comprising”. Further, the term “or” used in the present disclosure is intended not to be exclusive OR.

In the present disclosure, for example, when articles such as “a”, “an”, and “the” in English are added by translation, the present disclosure may include that nouns following these articles are plural.

In the present disclosure, a sentence “A and B are different” may mean that “A and B are different from each other”. The sentence may mean that “each of A and B is different from C”. Terms such as “separate”, “coupled”, and the like may also be interpreted, similar to “different”.

### REFERENCE SIGNS LIST

1 Virtual space presenting system
10 Server (virtual space presenting device)
11 Acquisition unit
12 Generation unit
13 Presentation unit
14 Setting unit
20A, 20B User terminal
30A, 30B HMD
A1 Avatar (first avatar)
A3 Avatar
IM Virtual space video
P1 First portion
P2 Second portion
VS Virtual space

1. A virtual space presenting device for presenting a three-dimensional virtual space shared by a plurality of users to each user, the virtual space presenting device comprising:
an acquisition unit configured to acquire video data obtained by photographing users;
a generation unit configured to generate avatars to be arranged in the virtual space in correspondence with the users on the basis of the video data of the users; and
a presentation unit configured to generate and present videos corresponding to visual fields from virtual viewpoints of the users set in the virtual space with respect to the users,
wherein the acquisition unit is configured to be able to acquire first video data in which a first portion of a body of a first user is shown within video data obtained by photographing the first user in a plurality of different directions without acquiring second video data in which a second portion different from the first portion of the body of the first user is shown during a first period, and
wherein, when the acquisition unit acquires the first video data without acquiring the second video data during the first period, the generation unit
generates the first portion of a first avatar corresponding to the first user for the first period on the basis of the first video data acquired during the first period, and
generates the second portion of the first avatar for the first period on the basis of the second video data acquired during a second period earlier than the first period.

2. The virtual space presenting device according to claim 1, further comprising a setting unit configured to set a portion of the first avatar visible to a second user who is a user different from the first user among the plurality of users as the first portion on the basis of the virtual viewpoint of the second user and set a portion of the first avatar invisible to the second user as the second portion.

3. The virtual space presenting device according to claim 1, further comprising a setting unit configured to acquire movement information about movement of a body of the first user, set a portion of which predetermined movement or more has been detected within the body of the first user as the first portion on the basis of the movement information, and set a portion of which predetermined movement or more has not been detected within the body of the first user as the second portion.

4. The virtual space presenting device according to claim 3, wherein the setting unit
sets a whole body of the first user as the first portion in an initial state,
changes a portion of which predetermined movement or more has not been detected continuously during a predetermined period within the first portion to the second portion, and
changes the second portion of which movement has been detected to the first portion when the predetermined movement or more has been detected in the second portion.
